(19) United States
(12) Patent Application Publication
(10) Pub. No.: US 2007/0031107 A1
(43) Pub. Date: Feb. 8, 2007

(54) Light-guiding structure

(75) Inventor: Ho-Wen Kuo, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/323,713

(22) Filed: Dec. 30, 2005

(30) Foreign Application Priority Data
Aug. 8, 2005 (TW) 094213438

(51) Int. Cl. G02B 6/10

(52) U.S. Cl. 385/146

(57) ABSTRACT

A light-guiding structure is proposed, which is applicable to a panel of an electronic device, the panel having a first bonding portion. The light-guiding structure includes a light-guiding base and a plurality of light-guiding poles. The light-guiding base has a second bonding portion for being coupled to the first bonding portion. The light-guiding poles are mounted to the light-guiding base, for guiding light emitted by light source such as a light emitting diode (LED) provided under the panel to a region above the panel. Therefore, assembly and disassembly processes are becoming simple and quick and drawbacks of the conventional technology can be solved.

### FIELD OF THE INVENTION

The present invention relates to light-guiding structures, and more particularly, to a light-guiding structure having a plurality of light-guiding poles for guiding light emitted by a light source such as a light emitting diode (LED) provided under a panel to a region above the panel.

### BACKGROUND OF THE INVENTION

With rapid development of the science and technology, application of the electronic device with powerful function has become more and more wide and indispensable to daily life and work. As to the enterprise, it is quite important for the modern data transfer to employ the electronic device, such as server, under Internet environment to collect and administrate data and information by virtue of the server managing manner.

The electronic device, e.g., server, is installed in a machine cabinet pile by pile or side by side, so as to provide working environment for the electronic device to run stably. Generally, a plurality of hard discs can be mounted in the server by specification, and each of the hard discs has a required system. In order to perform maintenance operation conveniently, LED lights for indicating service state of the system are assembled in the server. Accordingly, a manager can easily identify the machines which are required administrating and maintaining according to the fault LED when abnormality of the system occurs.

However, when a panel is mounted on a front surface of the server, the panel may block off the below LED light, the manager must observe the LED light from a special angle through an obligated hole on the panel for identifying, which is adverse to judge the system state in the central region of LED light.

Simultaneously, so far as the central region of LED light is concerned, if each LED light is required to shift up to the panel, the design may become quite complicated. In addition, several single light-guiding poles are set and protruded on the panel of the server, there is correlative patent such as Taiwan Innovation Patent Certificate No. M246604. However, if a light-guiding pole is set corresponding to each LED light in the central region of LED light, distance among various light-guiding poles is too near to assemble and disassemble difficultly.

Accordingly, there exists a strong need in the art for a light-guiding structure to solve various drawbacks of the above-described conventional technology, so as to assemble and disassemble simply and quickly.

### SUMMARY OF THE INVENTION

Accordingly, it is an objective of the present invention to solve the drawbacks of the aforementioned conventional technology by providing a light-guiding structure which can be assemble and disassembled simply and quickly.

It is another objective of the present invention to provide a light-guiding structure which can be assembled and disassembled without tools.

It is a further objective of the present invention to provide a light-guiding structure which can be assembled and disassembled with a plurality of light-guiding poles at one time.

In order to attain the object mentioned above and the others, a light-guiding structure is provided according to the present invention. The light-guiding structure is assembled to a panel of an electronic device, the panel having a first bonding portion. The light-guiding structure includes a light-guiding base and a plurality of light-guiding poles. The light-guiding base has a second bonding portion corresponding to the first bonding portion and for being coupled to the first bonding portion. The light-guiding poles are mounted to the light-guiding base for guiding light emitted by a light source such as a LED provided under the panel to a region above the panel.

Preferably, the light-guiding base is made of photic material, and the photic material is acrylic material or other equivalent structure. The second bonding portion has an M-shaped structure. The light-guiding base further includes at least a spring section and a supporting section. The spring section is installed at both sides of the light-guiding base. Each of the spring sections is extended from the second bonding portion and buckled upwards, and has a structure of an inverted U shape. The supporting section has a blocking structure buckled downwards from the light-guiding base. Each of the light-guiding poles has a cylindrical structure and is made of photic material. The photic material is acrylic material or other equivalent structure. In a preferred embodiment, the light-guiding poles are integrated with and penetrate the light-guiding base, but it is not limited to this. In other words, the light-guiding base and the light-guiding poles can also be fabricated independently. The light-guiding pole has one selected from the group consisting of a geometrical structure and a non-geometrical structure. Preferably, the light-guiding pole has one selected from the group consisting of a cylindrical structure, a rectangular structure, a triangular structure, a star-shaped structure and other equivalent structure corresponding to each LED light in the central region of the LED light.

In the conventional technology, the manager must observe the LED light from the special angle through the obligated hole on the panel for identifying, which is adverse to judge the system state in the central region of LED light, compared with the conventional technology, the present invention can quickly assemble the light-guiding structure on the panel without tools, then lead the LED light under the panel to the external, which makes the manager watch the LED light clearly at a glance and easily identify the machines which are required administrating and maintaining according to the fault LED. Similarly, the light-guiding structure according to the present invention can also be disassembled from the panel without tools, which is helpful for the user to quickly assemble and disassemble, thereby there is convenience in use.

Accordingly, drawback of the conventional technology can be solved, and convenient maintenance work can be provided by the light-guiding structure that can be assembled and disassembled simply and quickly according to the present invention.

Simultaneously, application of the present invention doesn't have to shift each LED light that is assembled in the server for indicating service state of the system up to the panel, which can avoid the complicated design caused by the conventional technology, and the present invention further can avoiding from assembling and disassembling difficultly when a light-guiding pole is set corresponding to each LED light in the central region of LED light.

Furthermore, application of the present invention doesn't need tools when assembling and disassembling, which solves the difficulty when assembling and disassembling in the conventional technology, and even provides the user with excellent convenience in use. In addition, the light-guiding structure according to the present invention can assemble multiple light-guiding poles at once time for respectively leading out the LED light in the central region of the LED light, compared with the conventional technology that sets a light-guiding pole according to each LED light, time and manpower required during assembly and disassembly can be saved.

As described above, application of the present invention can solve various problems, such that it is adverse to judge the system state in the central region of LED light, complicated to design and unease to assemble and disassemble, etc., in the conventional technology, thereby assembly and disassembly can be simple and quick without tools, and a plurality of light-guiding poles can be assembled and disassembled at once time, there is indeed high value in use of the industry.

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

### BRIEF DESCRIPTION OF DRAWINGS

The present invention can be more fully understood by reading the following detailed description of the preferred embodiments, with reference made to the accompanying drawings, wherein:

FIG. 1A is a schematic diagram of a light-guiding structure according to a preferred embodiment of the present invention;

FIG. 1B is a rear view of the light-guiding structure shown in FIG. 1A;

FIG. 2 is a schematic diagram of a panel of an electronic device for use with the light-guiding structure shown in FIG. 1A of the preferred embodiment according to the present invention; and

FIG. 3 is a schematic diagram of an assembled structure of the light-guiding structure shown in FIG. 1A and the panel shown in FIG. 2.

### DETAILED DESCRIPTION OF PREFERRED EMBODIMENTS

The following implementation is further described the concept of the present invention, but it is not to limit the scope of the present invention.

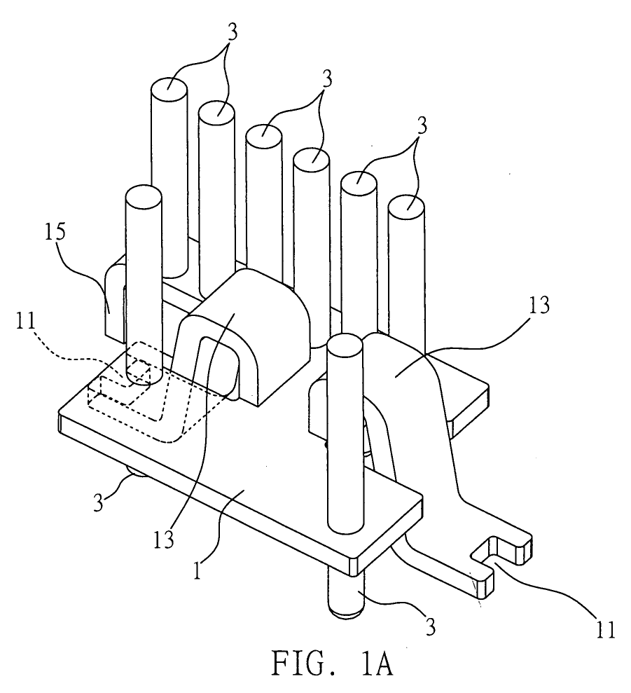

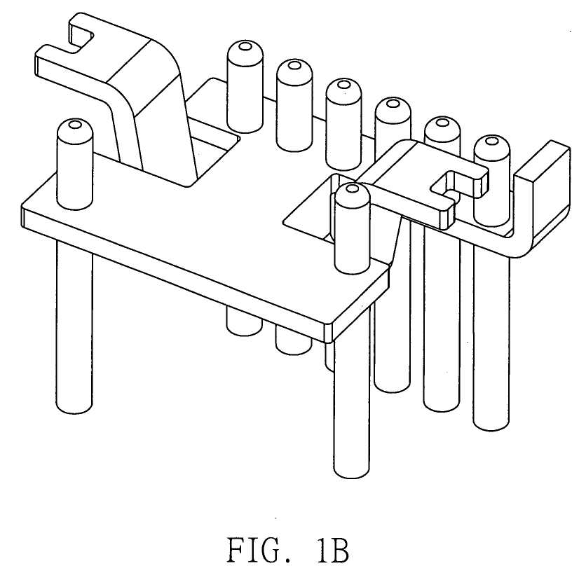

Please refer to FIGS. 1A through 3, which are four schematic diagrams of the preferred embodiment according to the present invention. The light-guiding structure according to the present invention can be assembled to a panel of an electronic device, the panel having at least a first bonding portion. The electronic device is used hereafter, but is not limited to, as an exemplary embodiment. Since the above and other conventional electronic devices are applicable to the present invention, its structure is not changeable, for simplicity, in order to illustrate the feature and structure of the present invention in a more clear and concise manner, merely the structure directly pertaining to the present invention is illustrated, the other is left out.

As shown in FIGS. 1A and 1B, the light-guiding structure of the embodiment comprises a light-guiding base 1 and a plurality of light-guiding poles 3.

According to the preferred embodiment, the light-guiding base 1 is made of photic material, e.g., acrylic material. The light-guiding base 1 comprises a second bonding portion 11 corresponding to the first bonding portion and for being coupled to the first bonding portion (as described below), two spring sections 13 and a supporting section 15. In the exemplary embodiment, the second bonding portion 11 has an M-shaped structure. The spring sections 13 are installed symmetrically, extended from second bonding portions 11 and buckled upwards, and have a structure in an inverted U shape. The supporting section 15 has a blocking structure buckled downwards from the light-guiding base 1.

The light-guiding poles 3 are mounted to the light-guiding base 1, and penetrate the light-guiding base 1. In the exemplary embodiment, the light-guiding poles 3 are integrated with the light-guiding base 1, and are made of photic material, e.g., acrylic material. Therefore, the light-guiding base 1 is easy to be fabricated and assembled.

However, the light-guiding poles 3 need not to be integrated with the light-guiding base 1. For example, in other exemplary embodiment, the light-guiding base 1 and the light-guiding poles 3 can be formed independently, and then the light-guiding poles 3 are assembled to the light-guiding base 1, so as to easily replace any damaged light-guiding pole 3. The light-guiding poles 3 have a cylindrical structure and are made of photic material, e.g., acrylic material or others. Although eight light-guiding poles 3 having the cylindrical structure are installed in the embodiment, it should be understood that a number of the light-guiding poles 3 corresponds to another number of LED lights in a central region of an LED of the electronic device. The light-guiding poles 3 have a geometrical structure or a non-geometrical structure, such as a rectangular structure, a triangular structure, a star-shaped structure and the like, but it is not limited to the embodiment and can be changed as required.

In addition, in the exemplary embodiment, the light-guiding poles 3 are respectively corresponding to the LED lights (not illustrated) in the central region of the panel, but are not penetrated deeply into the panel. In other embodiment, the light-guiding poles 3 can also be respectively corresponding to LED lights in the central region of the panel and are slightly penetrated into the panel, and not limited to what described in the exemplary embodiment, it is apparent to those skilled in the art, so it will not be described more.

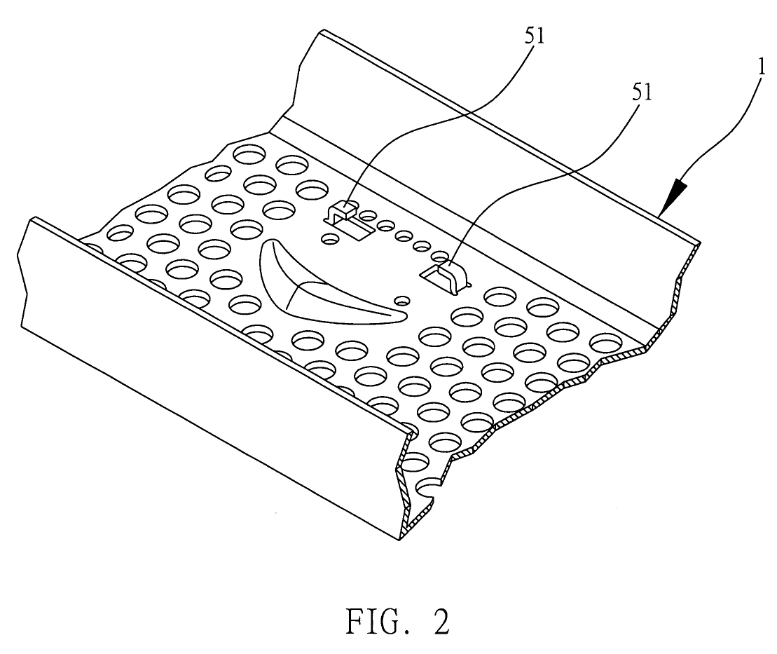

With reference to FIG. 2, the panel 5 can be the panel of the electronic device, e.g., a server. The panel 5 comprises at least two first bonding portions 51, which are symmetrically installed on the panel 5 in the exemplary embodiment. Each of the bonding portion 51 has a hook-shaped structure extended upwards from the panel 5 and buckled partially.

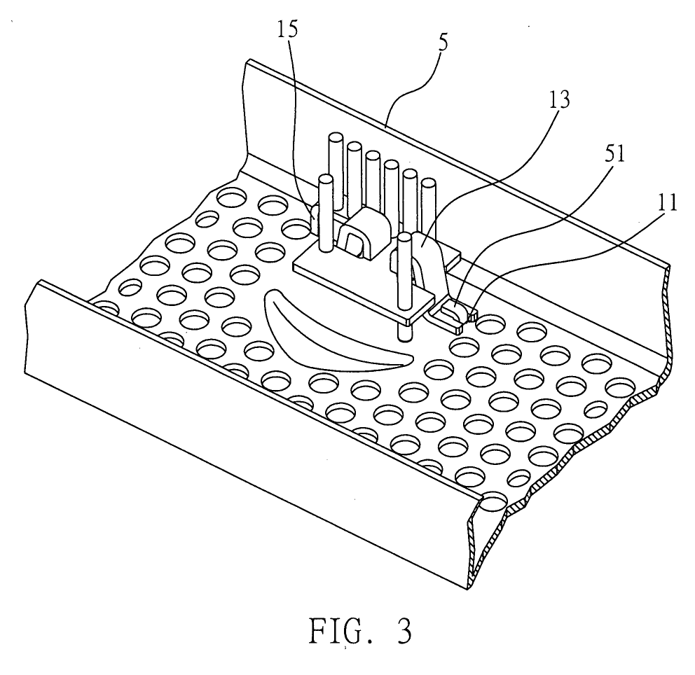

When the light-guiding structure of the present invention is to be assembled to the panel 5, only the second bonding portion 11 is needed to be engaged with the first bonding portion 51, and the light-guiding structure can be assembled to the panel 5. For example, making the second bonding portion 11 to be engaged with the first bonding portion 51 and joint to the external surface of the panel 5, and making the supporting section 15 support the light-guiding structure on the external surface of the panel 5, the light-guiding poles 3 are respectively corresponding to each LED light in the central region of the LED light of the server for guiding the light emitted by the LED provided under the panel 5 to a region above the panel 5. It is shown as FIG. 3 after finishing assembly.

It should be noted that the number and position of the LEDs in the central region of the server can be designed according to different specifications and requirements. Therefore, the position and number of the light-guiding poles 3 are installed according to those of various LED lights, the exemplary embodiment is to describe the present invention as illustrative and not restrictive.

Meanwhile, if the second bonding portion 11 is needed to be locked and bonded to the first bonding portion 51, just slightly pressing the spring section 13 by the fingers, making the spring section 13 provide a telescopic spring space without other auxiliary means, so that the second bonding portion 11 retracts inwards, and releasing the force for pressing the spring section 13 after locking the second bonding portion 11 to the first bonding portion 51, which makes the second bonding portion 11 extend outside, thereby assembly can be performed more successfully.

Certainly, one or at least two spring sections 13 can also be installed in other embodiment for providing telescopic spring space, and the spring section 13 is not limited to the embodiment that is installed symmetrically. In other words, any component can be used in the present invention, as long as the component can provide telescopic spring space and will not affect the bonding of the second bonding portion 11 and the first bonding portion 51, all of which can be suitable for the present invention, and such changes are apparent to those skilled in the art and can be modified by them, so it will not be described again.

As long as unchaining the bonding state between the second bonding portion 11 and the first bonding portion 51, the light-guiding structure according to the embodiment can be disassembled. For example, firstly, slightly pressing the spring section 13 by fingers, making the second bonding portion 11 retract inwards and release from the locking state with the first bonding portion 51 without tools, and then the light-guiding structure can be taken off the panel 5. Of course, those skilled in the art should realize that the present invention is not limited to the above assembling and disassembling process and can be altered as required.

The difference between the present invention and the prior art is that the light-guiding structure can be assembled to or disassembled from the panel 5 of electronic device without tools. Therefore, it is easy to assemble and dissemble, and convenient to assemble and dissemble quickly, thereby solving the difficulty when assembling and disassembling in the conventional technology.

Meanwhile, the light-guiding structure according to the present invention does not need tools when being assembled and disassembled, this is helpful for the use to quickly assemble and dissemble, and even provides convenience in use. Therefore, the light-guiding structure according to the present invention can save much more time and effort than the conventional technology. In addition, the present invention can be applied in the present electronic device and electronic device with new design, thereby upgrading design spring.

Furthermore, a light-guiding structure which can assemble and disassemble multiple light-guiding poles at once time is provided according to the present invention, it is not necessary to shift each LED light in the central region of the LED light up to the panel and provide a light-guiding pole and set a light-guiding pole according to each LED light in the central region of the LED light. Accordingly, it becomes simple in design and easy in assembly, thereby making the manager easily identify the machines which are required administrating and maintaining according to the fault LED.

Therefore, application of the present invention can solve the difficulty in assembly and disassembly of the conventional technology, thereby assembly and disassembly can be simple and quick without tools, and a plurality of light-guiding poles can be assembled and disassembled at once time for leading the LED light under the panel to the external, which upgrades design spring.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A light-guiding structure applicable to a panel of an electronic device, the panel having a first bonding portion, the light-guiding structure comprising:
a light-guiding base having a second bonding portion for being coupled to the first bonding portion; and
a plurality of light-guiding poles mounted to the light-guiding base, for guiding light emitted by a light source provided under the panel to a region above the panel.

2. The light-guiding structure of claim 1, wherein the light-guiding base has a base structure made of a photic material.

3. The light-guiding structure of claim 2, wherein the photic material is an acrylic material.

4. The light-guiding structure of claim 1, wherein the second bonding portion has an M-shaped structure.

5. The light-guiding structure of claim 1, wherein the light-guiding base further comprises at least one spring section and a supporting section.

6. The light-guiding structure of claim 5, wherein the light-guiding base comprises two spring sections.

7. The light-guiding structure of claim 6, wherein each of the spring sections is extended from the second bonding portion and is bent to form an inverted U-shaped structure.

8. The light-guiding structure of claim 5, wherein the supporting section is a blocking structure bent downwards from the light-guiding base.

9. The light-guiding structure of claim 1, wherein each of the light-guiding poles has a cylindrical structure made of a photic material.

10. The light-guiding structure of claim 9, wherein the photic material is an acrylic material.

11. The light-guiding structure of claim 1, wherein the light-guiding poles are integrated with and penetrate the light-guiding base.

12. The light-guiding structure of claim 1, wherein each of the light-guiding poles has one of a geometrical structure and a non-geometrical structure.

13. The light-guiding structure of claim 1, wherein each of the light-guiding poles has one of a cylindrical structure, a rectangular structure, a triangular structure, and a star-shaped structure.

14. The light-guiding structure of claim 1, wherein the light source is a light emitting diode.
